(19) United States
(12) Patent Application Publication
(10) Pub. No.: US 2026/0330825 A1
(43) Pub. Date: Oct. 22, 2026

(54) BUILDING INTERIOR STRUCTURE RECOGNITION SYSTEM AND BUILDING INTERIOR STRUCTURE RECOGNITION METHOD

(71) Applicant: TOPCON CORPORATION, Tokyo (JP)

(72) Inventors: Toru ITO, Wako (JP); Yasufumi FUKUMA, Wako (JP); Zaixing MAO, Wako (JP); Hisashi TSUKADA, Wako (JP)

(21) Appl. No.: 19/104,675

(22) PCT Filed: Aug. 18, 2022
(86) PCT No.: PCT/JP2022/031247

§ 371 Date: Feb. 18, 2025

(51) Int. Cl. G06V 20/10; G06V 10/30; G06V 10/774

(52) U.S. Cl. CPC G06V 20/176; G06V 10/30; G06V 10/774

(57) ABSTRACT

This building interior structure recognition system comprises: a first machine learning model generation unit that uses BIM data and a first site image to generate a first machine-learned model; a second machine learning model generation unit that uses a second site image containing an image of a noise component to carry out relearning with respect to the first machine-learned model; a scanning unit that scans the interior of a building while determining whether scanning of a structure inside the building is successful, and acquires a third site image and 3D point cloud data of a structure inside the building; a noise component removal unit that extracts an image of a noise component; a third machine learning model generation unit uses the image of the noise component to carry out relearning with respect to the second machine-learned model; a building interior structure recognition unit that uses the third machine-learned model to recognize a structure inside the building; and a point group data output unit that extracts and outputs point cloud data of the structure inside the building.

### TECHNICAL FIELD

The present invention relates to a building interior structure recognition system and a building interior structure recognition method, and in particular to a building interior structure recognition system that recognizes a structure disposed in a building of a construction such as a multi-story building by using deep learning based on a neural network, a building interior structure recognition method, and a program.

### BACKGROUND ART

Conventionally, as methods for checking a construction situation of a construction such as a multi-story building under construction, a human checks the construction situation at a construction site using a two-dimensional construction drawing or the like by making direct measurements using instruments or the like, or the construction situation is compared with a BIM (Building Information Modeling) model using remote sensing technology capable of measuring a distance using reflected light, such as LiDER (Light Detection and Ranging).

However, there has been a problem that when making measurements using LiDER or the like, it is necessary to measure multiple parts of the construction site depending on the situation of the site based on experiences, and accuracy of obtained data varies depending on a skill level of a measurer. Further, there has been a problem that it takes time and effort to register obtained point cloud data and to manually identify structures in the building such as pipes and measure their positions and sizes. Additionally, there have been a problem with the accuracy of the captured point cloud data and data obtained by processing it, and a problem of difficulty in reusing data.

It is realistically difficult to choose to make measurements at all points of the construction site with an emphasis on data accuracy because the amount of information would be enormous. When the measurer is highly skilled, it is possible to measure only the necessary points based on his or her own experience, however, automation of measurement is demanded to prevent variations due to skill levels and to improve measurement efficiency.

When considering automating determination of regions of structures disposed at a construction site and recognition of what those structures are in order to compare the construction situation of the construction site in the middle of construction with its completed form, it is expected to use a learned model by deep learning based on a neural network.

In order to create a learned model for automating the recognition of structures in an image, a necessary and sufficient number of images of the construction site are required as input data for learning. Further, annotations for structures included in the image, that is, results of the recognition of the structures in the image indicating which part of the image is what are required as correct data for learning. However, it is difficult to collect a large number of photographic images of an actual construction site that can be used for learning as the input data, and to annotate a huge number of structures for use as the correct data.

Further, it is also conceivable to create a learned model by executing machine learning using rendered images obtained by rendering a completed 3D model of the construction site so that it closely resembles the actual appearance, rather than photographs of the actual construction site. However, rendered images are mainly created for commercial purposes of a construction, and their production costs are high, so it is difficult to prepare rendered images as a necessary and sufficient number of learning images for learning. Further, the work of annotating structures included in rendered images also becomes enormous, and requires time and effort to be performed manually.

Therefore, there is a need to be able to prepare a necessary and sufficient number of learning images related to a construction site for learning, and to automate the annotation of structures included in the learning images. Further, there is a need to be able to recognize structures with high accuracy by using the thus created learned model.

Furthermore, at the actual construction site, various articles such as wire nets, protective nets and sheets, temporarily installed iron fences and poles, garbage, and building materials are present other than structures as measurement targets. In addition, a person may be unintentionally imaged in the middle of site scanning work. These noise components obstruct the recognition of the structures as the measurement targets, and the recognition accuracy of the structures is affected.

Therefore, there is a need for a system capable of highly accurately recognizing site images containing the noise components such as wire nets, protective nets and sheets, temporarily installed iron fences and poles, garbage, and building materials that are present at the construction site. Further, since an existing situation of such noise components changes every moment since they are moved or added according to the construction situation at the actual site, it is desirable to use a model tailored to the latest site situation. At that time, it is desirable to minimize the time and costs to regenerate the model tailored to the site.

In Non-Patent Literature 1, regarding the problem of a huge amount of point cloud data in as-built modeling in which a 3D model is created based on 3D measurement of an existing large-scale facility, the following has been pointed out: “It should be noted that measuring devices used for as-built modeling of large-scale facilities have a measuring principle different from that of point cloud measuring devices for small parts. For point cloud measurement of small parts, triangulation is generally performed using a laser output device and a CCD camera, but this method makes the device larger as the size of the object increases. Further, when small parts are measured, the measured point cloud is often several million points at most, but in the case of a large-scale facility, modeling requires a large amount of point cloud”.

For example, Patent Literature 1 discloses a construction production system including: “a CPU that functions as: existing portion investigation means for converting electronic data of an existing portion of a construction acquired from an existing drawing into 3D CAD data, and for storing the 3D CAD data together with various job site investigation data including point cloud data acquired by a 3D laser scanner and a 3D polygon model created from the point cloud data; construction member design means for disposing a member object to be newly constructed, which is selected from among member objects stored in advance in a member library, on the 3D polygon model; and member construction position output means for searching for and outputting the member object corresponding to an ID unique to the member object obtained by reading an electronic tag attached to a member precut in a member factory with an ID reader together with construction position information thereof from the 3D CAD model designed by the construction member design means according to the member object disposed by the construction member design means; and an automatic position pointing device for pointing a construction position of the member in the existing portion on the basis of construction position information of the member object output by the member construction position output means of the CPU”.

Further, Patent Literature 2 discloses “an image processing device including: an image acquisition unit that acquires an input image generated by imaging a real space using an imaging device; a recognition unit that recognizes a relative position and posture between the real space and the imaging device on the basis of one or more feature points imaged in the input image; an application unit that provides an augmented reality application using the recognized relative position and posture; and a display control unit that superimposes, on the input image, a guiding object that guides a user operating the imaging device in accordance with a distribution of the feature points so that recognition processing executed by the recognition part is stabilized”.

However, although Patent Literature 1 and Patent Literature 2 both disclose techniques for grasping a 3D space or an object in a 3D space, they do not particularly solve the problem of a huge amount of data such as 3D point cloud data in large-scale facilities such as multi-story buildings and factories, and are not suitable for automating the recognition of structures in an image in order to quickly grasp the situation of a construction site in the middle of construction.

Further, neither Patent Literature 1 nor Patent Literature 2 consider highly accurately recognizing target structures even for site images containing noise components such as wire nets, protective nets and sheets, temporarily installed iron fences and poles, garbage, and building materials that are present at the construction site, relearning a model according to the latest site situation, and the like.

### CITATION LIST

### Patent Literature

Patent literature 1: JP-A-2013-149119
Patent literature 2: JP-A-2013-225245

### Non Patent Literature

Non patent literature 1: Hiroshi Masuda, “Digitalization techniques for large-scale environments and their problems”, Collection of Lecture Papers from Academic Lectures at Conference by the Japan Society for Precision Engineering (Collection of Materials from Symposium at Conference by the Japan Society for Precision Engineering), 2007, Autumn, p.81-84, Sep. 3, 2007

### SUMMARY OF INVENTION

### Technical Problem

Therefore, the present invention solves the above problems and provides a building interior structure recognition system and a building interior structure recognition method that are capable of highly accurately recognizing a target structure even for a site image containing noise components such as wire nets, protective nets and sheets, temporarily installed iron fences and poles, garbage, and building materials that are present at the construction site, and highly accurately recognizing a structure according to a latest site situation.

Further, the present invention provides a program that causes a computer to execute each step of the building interior structure recognition method.

### Solution to Problem

In order to solve the above problems, the present invention provides a building interior structure recognition system for recognizing a structure inside a building by using a machine learning model, the building interior structure recognition system including: a first machine learning model generation unit that uses BIM (Building Information Modeling) data and a first site image to carry out machine learning and generates a first machine-learned model; a second machine learning model generation unit that uses a second site image containing an image of a noise component that does not have the BIM data to carry out relearning with respect to the first machine-learned model, and generates a second machine-learned model; a scanning unit that scans an interior of the building while determining whether or not scanning of the structure inside the building is successful, and acquires 3D point cloud data inside the building and a third site image; a noise component removal unit that removes the image of the noise component from the third site image acquired in the scanning unit; a third machine learning model generation unit that uses an image from which the noise component is removed and which is obtained in the noise component removal unit to carry out the relearning with respect to the second machine-learned model, and generates a third machine-learned model; a building interior structure recognition unit that uses the third machine-learned model to recognize the structure inside the building; and a point cloud data output unit that extracts and outputs point cloud data of the structure inside the building recognized in the building interior structure recognition unit from the 3D point cloud data acquired in the scanning unit.

In the building interior structure recognition system according to an aspect of the present invention, the first machine learning model generation unit carries out the machine learning with an image generated from the BIM data as correct data and with an image obtained by processing an image generated by rendering the BIM data using information obtained from the first site image as observation data, and generates the first machine-learned model.

In the building interior structure recognition system according to an aspect of the present invention, the second machine learning model generation unit inputs a set of correct data and observation data for the second site image containing the image of the noise component that does not have the BIM data to the first machine-learned model to carry out the relearning, and generates the second machine-learned model.

In the building interior structure recognition system according to an aspect of the present invention, the scanning unit acquires an image inside the building, determines whether or not at least one or more corresponding reference points or structures to be references are present between continuous frames, and notifies an alert urging rescanning when the at least one or more corresponding reference points or structures to be references are not present.

In the building interior structure recognition system according to an aspect of the present invention, the noise component removal unit extracts the image of the noise component from the third site image acquired in the scanning unit by stereo matching, generates a mask image of the noise component, reconfigures the image so as to interpolate a part of the mask image, and generates the image from which the noise component is removed.

In the building interior structure recognition system according to an aspect of the present invention, the third machine learning model generation unit inputs a set of correct data and observation data for an image obtained by removing the noise component from the third site image in the noise component removal unit to the second machine-learned model to carry out the relearning, and generates the third machine-learned model.

In the building interior structure recognition system according to an aspect of the present invention, the building interior structure recognition unit inputs the third site image to the third machine-learned model, and recognizes the structure inside the building contained in the third site image.

In addition, the present invention provides a building interior structure recognition method for recognizing a structure inside a building by using a machine learning model, the building interior structure recognition method including: a step of using BIM (Building Information Modeling) data and a first site image to carry out machine learning and generating a first machine-learned model; a step of using a second site image containing an image of a noise component that does not have the BIM data to carry out relearning with respect to the first machine-learned model, and generating a second machine-learned model; a scanning step of scanning an interior of the building while determining whether or not scanning of the structure inside the building is successful, and acquiring 3D point cloud data of the structure inside the building and an image inside the building; a step of removing the image of the noise component from the image inside the building acquired in the scanning unit; a step of using an image from which the noise component is removed and which is obtained in the removing step to carry out the relearning with respect to the second machine-learned model, and generating a third machine-learned model; a step of using the third machine-learned model to recognize the structure inside the building; and a step of extracting and outputting point cloud data of the structure inside the building recognized in the building interior structure recognition unit from the 3D point cloud data acquired in the scanning unit.

In the building interior structure recognition method according to an aspect of the present invention, the scanning step acquires the image inside the building, determines whether or not at least one or more corresponding reference points or structures to be references are present, and notifies an alert urging rescanning when the at least one or more corresponding reference points or structures to be references are not present.

Further, the present invention provides a program that causes a computer to execute each step of the building interior structure recognition method.

In the present invention, “BIM (Building Information Modeling) data” refers to data of a 3D model of a building reproduced on a computer.

### Advantageous Effects of Invention

The present invention exerts the effect that it is possible to highly accurately recognize even a site image containing noise components such as wire nets, protective nets and sheets, temporarily installed iron fences and poles, garbage, and building materials that are present at a construction site.

In addition, it is possible to improve recognition accuracy of a structure by carrying out relearning of a model according to a latest site situation corresponding to the noise components that change every moment.

Further, since a user can be notified of success or failure of scanning in the middle of scanning the site and execution of rescanning can be urged on the spot when the scanning is inferior, it is possible to avoid redoing of scanning work later.

Other objects, features and advantages of the present invention will become apparent from the following description of embodiments of the present invention with reference to the accompanying drawings.

### BRIEF DESCRIPTION OF DRAWINGS

FIG. 1 is a schematic diagram illustrating the whole of a building interior structure recognition system according to the present invention.

FIG. 2 is a diagram illustrating a flow of each processing of the building interior structure recognition system according to the present invention.

FIG. 3 is a schematic diagram illustrating a first machine learning model generation unit of the present invention.

FIG. 4 is a schematic diagram illustrating a second machine learning model generation unit of the present invention.

FIG.. 5 is a schematic diagram illustrating a scanning unit of the present invention.

FIG. 6 is a schematic diagram illustrating a noise component removal unit of the present invention.

FIG. 7 is a schematic diagram illustrating a third machine learning model generation unit of the present invention.

FIG. 8 is a schematic diagram illustrating a building interior structure recognition unit of the present invention.

FIG. 9 is a diagram illustrating an entire flow of a building interior structure recognition method according to the present invention.

### DESCRIPTION OF EMBODIMENTS

### Embodiment 1

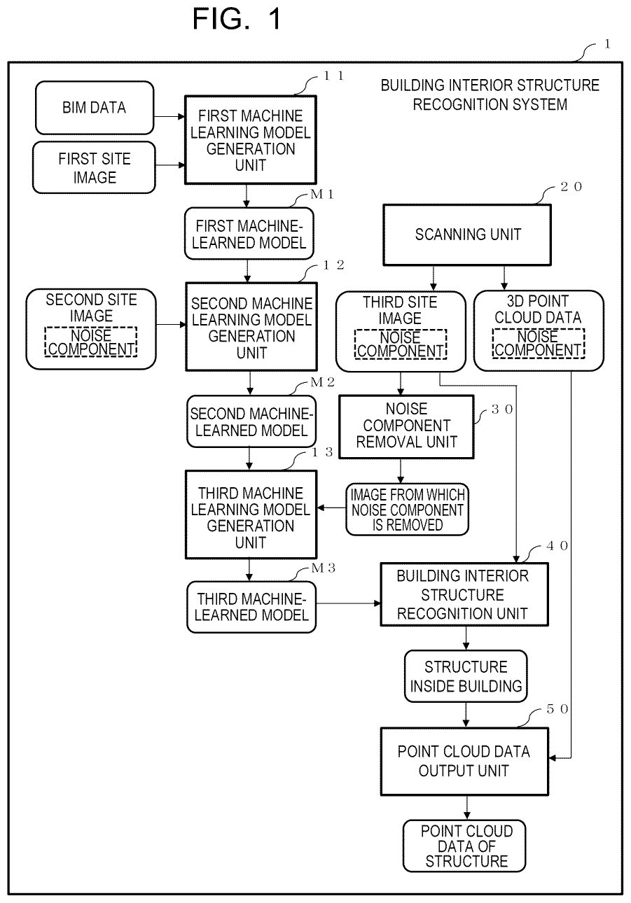

FIG. 1 is a schematic diagram illustrating the whole of a building interior structure recognition system 1 according to the present invention.

The building interior structure recognition system 1 according to the present invention includes: a first machine learning model generation unit 11 that uses BIM (Building Information Modeling) data and a first site image to carry out machine learning and generates a first machine-learned model; a second machine learning model generation unit 12 that uses a second site image containing an image of a noise component that does not have the BIM data to carry out relearning with respect to a first machine-learned model M1, and generates a second machine-learned model M2; a scanning unit 20 that scans an interior of a building while determining whether or not scanning of the structure inside the building is successful, and acquires 3D point cloud data inside the building and a third site image; a noise component removal unit 30 that removes the image of the noise component from an image inside the building acquired in the scanning unit 20; a third machine learning model generation unit 13 that uses an image obtained by removing the noise component from the third site image in the noise component removal unit to carry out the relearning with respect to the second machine-learned model, and generates a third machine-learned model M3; a building interior structure recognition unit 40 that uses the third machine-learned model M3 to recognize the structure inside the building; and a point cloud data output unit 50 that extracts and outputs point cloud data of the structure inside the building recognized in the building interior structure recognition unit from the 3D point cloud data acquired in the scanning unit.

The first machine learning model generation unit 11 uses the BIM (Building Information Modeling) data and the first site image to carry out the machine learning, and generates the first machine-learned model. Specifically, the first machine learning model generation unit 11 carries out the machine learning with an image generated from the BIM data as correct data and with an image obtained by processing an image generated by rendering the BIM data using information obtained from the first site image as observation data, and generates the first machine-learned model.

The second machine learning model generation unit 12 uses the second site image containing the image of the noise component that does not have the BIM data to carry out the relearning with respect to the first machine-learned model M1, and generates the second machine-learned model M2. Specifically, the second machine learning model generation unit 12 inputs a set of the correct data and the observation data for the second site image containing the image of the noise component that does not have the BIM data to the first machine-learned model to carry out the relearning, and generates the second machine-learned model.

The scanning unit 20 scans the interior of the building while determining whether or not the scanning of the structure inside the building is successful, and acquires the 3D point cloud data inside the building and the third site image. The scanning unit 20 acquires the image inside the building, determines whether or not at least one or more corresponding reference points or structures to be references are present, and notifies an alert urging rescanning when the at least one or more corresponding reference points or structures to be references are not present.

The noise component removal unit 30 extracts the image obtained by removing the noise component from the image inside the building acquired in the scanning unit 20. The noise component removal unit 30 extracts the image of the noise component from the third site image acquired in the scanning unit 20 by stereo matching, generates a mask image of the noise component, reconfigures the image so as to interpolate a part of the mask image, and generates the image from which the noise component is removed.

The third machine learning model generation unit 13 uses the image from which the noise component is removed and which is extracted in the noise component removal unit to carry out the relearning with respect to the second machine-learned model, and generates the third machine-learned model M3. Specifically, the third machine learning model generation unit 13 inputs a set of the correct data and the observation data for the image obtained by removing the noise component from the third site image in the noise component removal unit 30 to the second machine-learned model to carry out the relearning, and generates the third machine-learned model.

The building interior structure recognition unit 40 uses the third machine-learned model M3 to recognize the structure inside the building. The building interior structure recognition unit 40 inputs the third site image to the third machine-learned model, and recognizes the structure inside the building contained in the third site image.

The point cloud data output unit 50 extracts and outputs the point cloud data of the structure inside the building recognized in the building interior structure recognition unit from the 3D point cloud data acquired in the scanning unit.

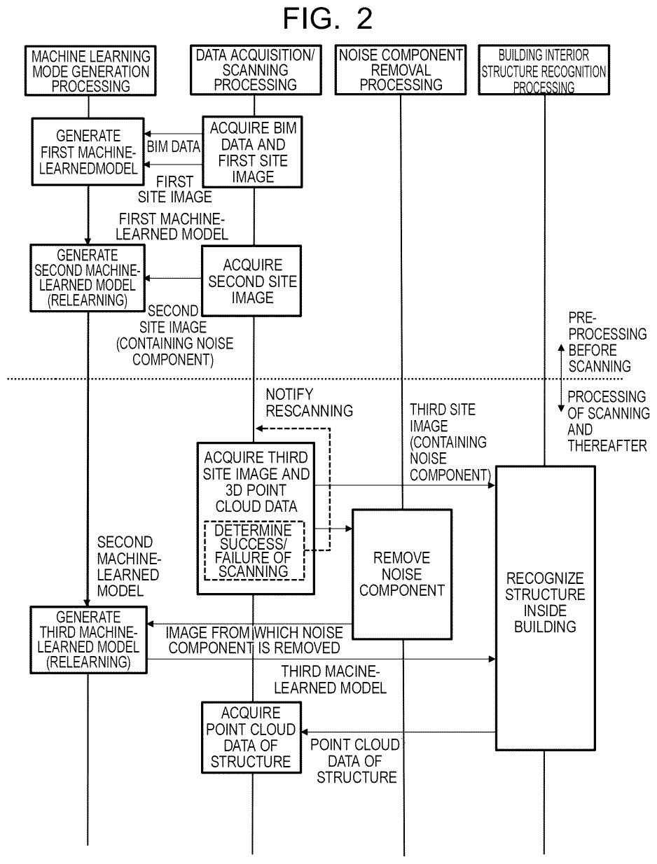

FIG. 2 is a diagram illustrating a flow of each processing of the building interior structure recognition system according to the present invention.

FIG. 2 illustrates respective relationships of machine learning model generation processing, data acquisition/scanning processing, noise component removal processing, and building interior structure recognition processing among the processing executed in the building interior structure recognition system. The machine learning model generation processing is executed by the first machine learning model generation unit 11, the second machine learning model generation unit 12, or the third machine learning model generation unit 13. The data acquisition/scanning processing is executed by the scanning unit 20 or the point cloud data output unit 50. Preprocessing before the scanning may be executed by an external arbitrary imaging device or scanning device that is not illustrated. The noise component removal processing is executed by the noise component removal unit 30. The building interior structure recognition processing is executed by the building interior structure recognition unit 40.

The flow of the entire processing is broadly divided into the preprocessing before the scanning and the processing of the scanning and thereafter. First, the preprocessing before carrying out main scanning at the site will be described. The preprocessing before the scanning includes generating the first machine-learned model and generating a second machine-learned model by carrying out the relearning with respect to the first machine-learned model. First, the BIM data and the first site image for generating the first machine-learned model are acquired. The acquired BIM data and first site image are used to generate the first machine-learned model. The first machine-learned model is created assuming an ideal site, and is generally usable for various sites. However, at an actual site, articles (such as wire nets, protective nets and sheets, temporarily installed iron fences and poles, garbage, and building materials) not included in the BIM data may be present in general. Further, in addition to such articles, a person may be unintentionally imaged. Therefore, the second site image containing such noise components to be noise for recognizing the structure inside the building is acquired, and the relearning is carried out with respect to the first machine-learned model in order to make it learn the noise components as the noise. By carrying out such relearning, the second machine-learned model tailored to the actual site situation is obtained. The second site image is acquired when inspecting the site before carrying out the main scanning at the site or the like.

Next, the processing of the main scanning at the site and thereafter will be described. The processing of the scanning and thereafter includes carrying out the scanning, removing the noise component, generating the third machine-learned model, recognizing the structure inside the building, and acquiring the point cloud data. First, the interior of the building which is the site is scanned, and the third site image and the 3D point cloud data are acquired. At that time, whether or not the scanning is successful is determined while carrying out the scanning, and when redoing of the scanning is needed, the alert urging the rescanning is notified. When the alert urging the rescanning is notified, the rescanning is carried out. This is repeated until all scanning targets inside the building are scanned. Then, the noise component is removed from the scanned third site image. The noise component present at the site often changes every moment, and a new noise component not contained in the second site image acquired in the preprocessing before the scanning may be contained in the third site image. In addition, the noise component contained in the second site image may be moved to another location. Unintentional imaging of a person or the like may also be the noise component. Therefore, the noise component is removed from the scanned image, and the relearning is carried out with respect to the second machine-learned model in order to make it further learn the image from which the noise component is removed. By carrying out such relearning, the third machine-learned model tailored to the latest actual site situation is obtained. Next, the third machine-learned model is used to recognize the structure inside the building for the third site image. Finally, the 3D point cloud data corresponding to the recognized structure inside the building is obtained.

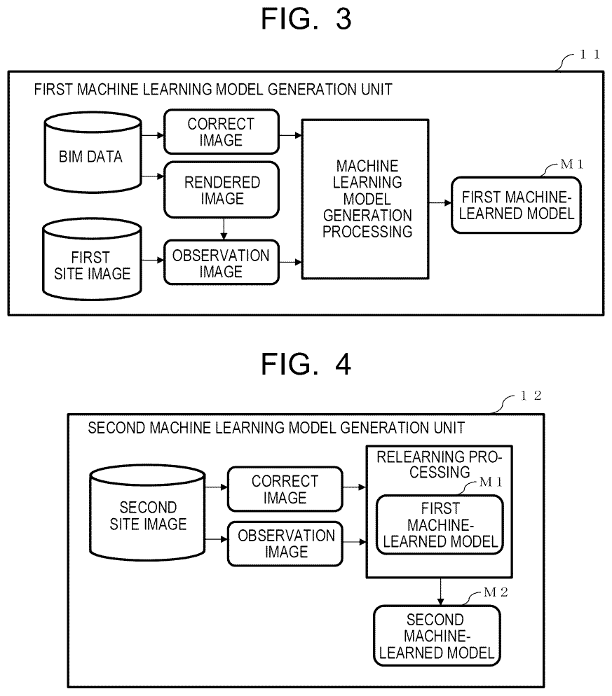

FIG. 3 is a schematic diagram illustrating the first machine learning model generation unit of the present invention.

The first machine learning model generation unit 11 carries out the machine learning with the image generated from the BIM data as the correct data (correct image) and with the image obtained by processing the image generated by rendering the BIM data using the information obtained from the first site image as the observation data (observation image), and generates the first machine-learned model. The correct data generated from the BIM data shows the structure in the image so as to be distinguished from a background. The correct image may be manually generated by manually painting out the part of the structure in the image for example. The correct image may be a binary image capable of distinguishing the part of the structure and a background part for example. Further, the observation image is also generated from the BIM data. First, a rendered image obtained by rendering the BIM data is generated.

Then, by using information of texture or the like extracted from the first site image, the texture or the like is added to the rendered image to generate the image closer to a photo of the actual site, and it is used as the observation image. The set of such correct image and observation image is used to carry out the machine learning model generation processing, and the first machine-learned model M1 is generated. The first machine-learned model M1 can be used as a general machine-learned model for recognizing the structure inside the building. In particular, when carrying out the scanning for the interior of the building in an ideal environment without presence of the noise component to recognize the structure inside the building, the first machine-learned model M1 can be used.

FIG. 4 is a schematic diagram illustrating the second machine learning model generation unit 12 of the present invention.

The second machine learning model generation unit 12 inputs the set of the correct data and the observation data for a noise component image that is contained in the second site image and does not have the BIM data to the first machine-learned model M1 to carry out the relearning, and generates the second machine-learned model M2. When generating the first machine-learned model M1, the correct image and the observation image are generated based on the BIM data and are used for the machine learning so that the first machine-learned model M1 is suitable for the case of scanning an ideal building interior environment without the presence of the noise component. On the other hand, at the actual site, the noise component that does not have the BIM data is often present. Therefore, by having the first machine-learned model M1 additionally learn the second site image containing the noise component, the second machine-learned model M2 capable of accurately recognizing the structure even in a building interior environment containing the noise component is generated. The set of the correct image and the observation image to be used in the relearning with respect to the first machine-learned model M1 is generated from the second site image. The correct image of the second site image shows the structure so as to be distinguished from the background. The correct image of the second site image may be manually generated by manually painting out the part of the structure in the image for example. The correct image of the second site image may be a binary image capable of distinguishing the part of the structure and the background part for example. For the observation image of the second site image, the second site image containing the noise component may be used as it is. In addition, for the observation image of the second site image, an image obtained by processing the second site image containing the noise component in the preprocessing as needed may be used. The set of such correct image and observation image of the second site image is used to carry out relearning processing with respect to the first machine-learned model M1, and the second machine-learned model M2 is generated.

FIG. 5 is a schematic diagram illustrating the scanning unit of the present invention.

The scanning unit 20 acquires the image inside the building, determines whether or not at least one or more corresponding reference points or structures to be references are present, and notifies the alert urging the rescanning when the at least one or more corresponding reference points or structures to be references are not present. The scanning unit 20 may include a scanning success/failure determination unit 203, an alert notification unit 204, and a rescanning processing unit 205 for each function.

The scanning success/failure determination unit 203 determines whether or not at least one or more corresponding reference points or structures to be references are present. Here, the “reference point” refers to a point to be a reference for matching continuous frames, and for example, a marker or the like may be attached to the structure inside the building to be the reference point. Further, the “structure to be the reference” refers to a structure to be a reference for matching the continuous frames, and for example, a structure including a straight part such as a corner of a pillar may be the structure to be the reference.

The alert notification unit 204 notifies the alert urging the rescanning when the at least one or more corresponding reference points or structures to be references are not present. The alert is for notifying a user that the rescanning is needed, and may be display of an icon or a message on a display screen of a scanning device such as a ranging scanner 201 or an imaging device 202 or alarm sound or the like.

The rescanning processing unit 205 receives a rescanning instruction from the user and carries out the rescanning.

The processing in the scanning success/failure determination unit 203, the alert notification unit 204, and the rescanning processing unit 205 is repeated until the scanning of all scanning targets is ended, and when the scanning is ended, the third site image and the 3D point cloud data are acquired. The third site image and the 3D point cloud data acquired in the scanning unit 20 may contain the information of the noise component.

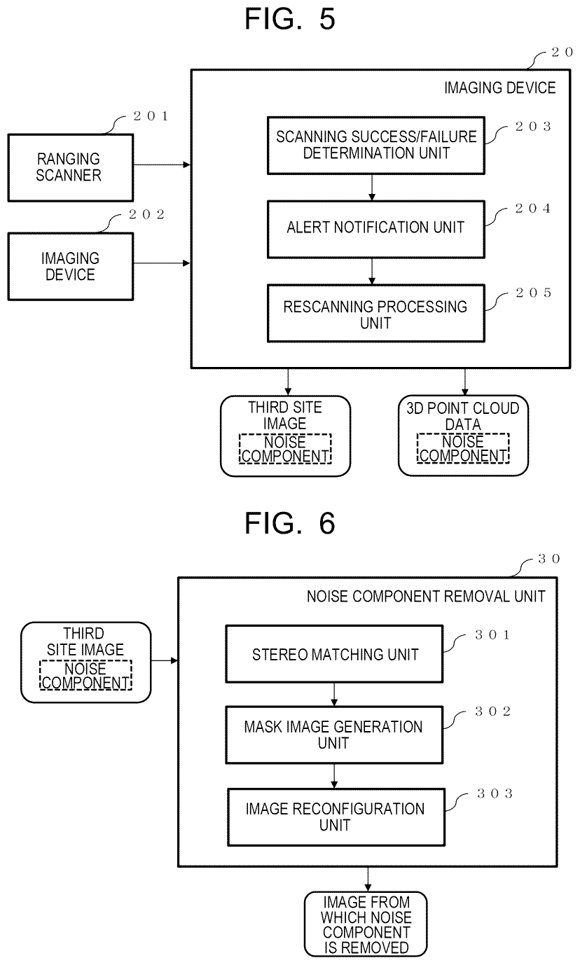

FIG. 6 is a schematic diagram illustrating the noise component removal unit of the present invention.

The noise component removal unit 30 extracts the image of the noise component from the third site image acquired in the scanning unit 20 by the stereo matching, generates the mask image of the noise component, reconfigures the image so as to interpolate the part of the mask image, and generates the image from which the noise component is removed. The noise component removal unit 30 may include a stereo matching unit 301, a mask image generation unit 302, and an image reconfiguration unit 303 for each function.

The stereo matching unit 301 inputs two images (typically a right image and a left image) obtained by imaging the same target from different viewpoints from the third site image acquired in the scanning unit 20 to an existing machine-learned model for carrying out the stereo matching, estimates a 3D depth for each pixel, and generates a distance image indicating the estimated depth for each pixel by gradation. The existing machine-learned model for carrying out the stereo matching may be a machine-learned model which is made to learn a mapping function for obtaining a parallax image indicating a parallax of the two images from the two images (typically the right image and the left image) obtained by imaging the same target from different viewpoints by a convolution neural network (CNN), for example. In addition, the existing machine-learned model for carrying out the stereo matching may be the one that uses a hierarchical network including a stacked cascade architecture for recursive refining and inference for updating the parallax from being coarse to being fine.

In another aspect, the stereo matching unit 301 may use an existing stereo matching method which does not use the machine learning model, instead of the above method which uses the existing machine-learned model for the stereo matching. In this case, for example, the 3D depth for each pixel may be estimated using two images (typically the right image and the left image) imaged from two points and the distance image indicating the estimated depth for each pixel by the gradation may be generated.

The mask image generation unit 302 carries out threshold processing to the distance image generated in the stereo matching unit 301, and generates the mask image of the noise component. For example, when a wire net which is the noise component is present in front of the structure as a recognition target, the mask image of a wire net part which is the noise component is generated.

The image reconfiguration unit 303 removes a mask part of the mask image generated in the mask image generation unit 302 from an original image, and obtains the image obtained by reconfiguring the image so as to interpolate the part of the mask image. The image reconfiguration unit 303 may input the third site image containing the noise component and the mask image of the noise component generated in the mask image generation unit 302 to the existing machine-learned model for reconfiguring the image, and may obtain the image reconfigured so as to remove a region of the mask image and to interpolate the part of the mask image. The existing machine-learned model for reconfiguring the image may be an existing machine-learned model generated by deep learning based on a neural network. Thus, the image reconfiguration unit 303 obtains the image obtained by removing the noise component from the third site image.

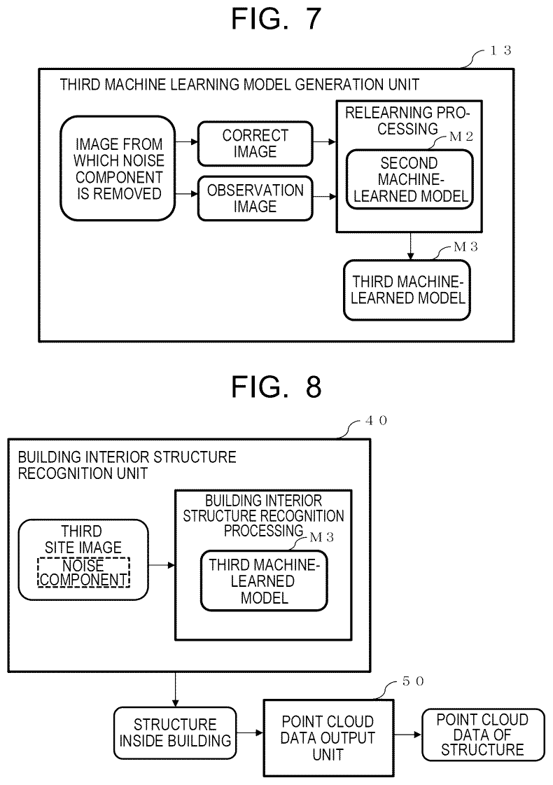

FIG. 7 is a schematic diagram illustrating the third machine learning model generation unit of the present invention.

The third machine learning model generation unit 13 inputs the set of the correct data and the observation data for the image obtained by removing the extracted noise component from the image inside the building, which is extracted in the noise component removal unit 30, to the second machine-learned model to carry out the relearning, and generates the third machine-learned model. When generating the second machine-learned model M2, the correct image and the observation image of the second site image containing the noise component, which is acquired in the preprocessing before the scanning, are used for the relearning. However, in order to cope even with a new noise component which has not been present at the time of the preprocessing before the scanning, the image obtained by removing the noise component from the third site image containing the noise component, which is acquired at the time of the main scanning, is additionally learned and thus, the third machine-learned model M3 capable of recognizing the structure further based on the target site is generated. The set of the correct image and the observation image to be used for the relearning with respect to the second machine-learned model M2 is generated from the image obtained by removing the noise component from the third site image in the noise component removal unit 30. The correct image of the image from which the noise component is removed shows the structure in the image so as to be distinguished from the background. The correct image of the image from which the noise component is removed may be manually generated by manually painting out the part of the structure in the image for example. The correct image of the image from which the noise component is removed may be a binary image capable of distinguishing the part of the structure and the background part for example. For the observation image of the image from which the noise component is removed, the image obtained by removing the noise component from the third site image containing the noise component may be used as it is. In addition, for the observation image of the image from which the noise component is removed, an image obtained by processing the image obtained by removing the noise component from the third site image containing the noise component in the preprocessing as needed may be used. The set of such correct image and observation image of the image from which the noise component is removed is used to carry out the relearning processing with respect to the second machine-learned model M2, and the third machine-learned model M3 is generated.

FIG. 8 is a schematic diagram illustrating the building interior structure recognition unit and the point cloud data output unit of the present invention.

The building interior structure recognition unit 40 inputs the third site image to the third machine-learned model M3, and recognizes the structure inside the building contained in the third site image. Output from the third machine-learned model M3 shows the structure inside the building in the image so as to be distinguished from the background. The output from the third machine-learned model M3 may be a binary image capable of distinguishing the part of the structure inside the building and the background part. The third site image may contain the noise component present at the time of scanning the site. The third machine-learned model M3 is made to additionally learn the image obtained by removing the noise component from the third site image containing the noise component, and can accurately recognize the structure inside the building even when the third site image contains the noise component.

The point cloud data output unit 50 extracts the 3D point cloud data of a part corresponding to the recognized structure inside the building from the 3D point cloud data scanned in the scanning unit 20 based on image information of the structure inside the building recognized in the building interior structure recognition unit 40, and outputs the data as point cloud data. Thus, the 3D point cloud data of the structure inside the building is obtained, and by carrying out rendering or the like with respect to the obtained 3D point cloud data, the data can be used for a purpose of generating 3D CAD data inside the building containing the structure or the like.

Hereinafter, a building interior structure recognition method for recognizing the structure inside the building by using the machine learning model will be described.

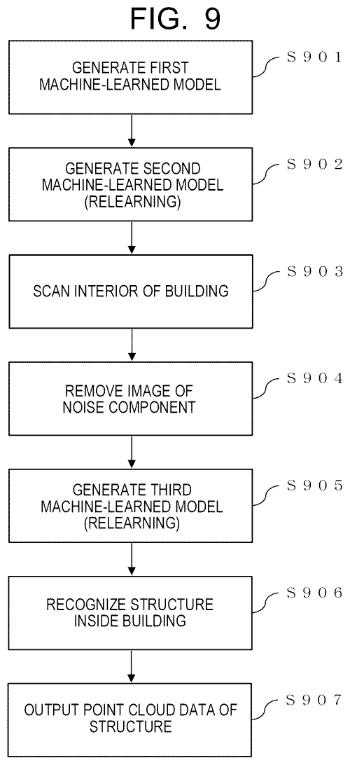

FIG. 9 is a diagram illustrating an entire flow of the building interior structure recognition method according to the present invention.

The building interior structure recognition method according to the present invention includes: a step S901 of using the BIM (Building Information Modeling) data and the first site image to carry out the machine learning and generating the first machine-learned model; a step S902 of using the second site image containing the image of the noise component that does not have the BIM data to carry out the relearning with respect to the first machine-learned model M1, and generating the second machine-learned model M2; a scanning step S903 of scanning the interior of the building while determining whether or not the scanning of the structure inside the building is successful, and acquiring the 3D point cloud data of the structure inside the building and the image inside the building; a step S904 of removing the image of the noise component from the image inside the building acquired in the scanning unit; a step S905 of using the image from which the noise component is removed and which is obtained in the removing step to carry out the relearning with respect to the second machine-learned model M2, and generating the third machine-learned model M3; a step S906 of using the third machine-learned model M3 to recognize the structure inside the building; and a step S907 of extracting and outputting the point cloud data of the structure inside the building recognized in the building interior structure recognition unit from the 3D point cloud data acquired in the scanning unit.

In the building interior structure recognition method according to an aspect of the present invention, the scanning step S903 acquires the image inside the building, determines whether or not at least one or more corresponding reference points or structures to be references are present, and notifies the alert urging the rescanning when the at least one or more corresponding reference points or structures to be references are not present.

Further, the present invention provides a program that causes a computer to execute each step of the building interior structure recognition method.

### Embodiment 2

Hereinafter, as the embodiment 2, an example of not including the second machine learning model generation unit 12 in the building interior structure recognition system 1 described in the above embodiment 1, and an example of not including the step of generating the second machine-learned model in the building interior recognition method described in the above embodiment 1 will be described. Points not described in particular below are same as the building interior structure recognition system 1 in the embodiment 1.

The building interior structure recognition system for recognizing the structure inside the building by using the machine learning model in the embodiment 2 includes: the first machine learning model generation unit 11 that uses the BIM (Building Information Modeling) data and the first site image to carry out the machine learning and generates the first machine-learned model M1; the scanning unit 20 that scans the interior of the building while determining whether or not the scanning of the structure inside the building is successful, and acquires the 3D point cloud data inside the building and the third site image; the noise component removal unit 30 that removes the image of the noise component from the image inside the building acquired in the scanning unit 20; the third machine learning model generation unit 13 that uses the image from which the noise component is removed and which is obtained in the noise component removal unit 30 to carry out the relearning with respect to the first machine-learned model M1, and generates the third machine-learned model M3; the building interior structure recognition unit 40 that uses the third machine-learned model M3 to recognize the structure inside the building; and the point cloud data output unit 50 that extracts and outputs the point cloud data of the structure inside the building recognized in the building interior structure recognition unit 40 from the 3D point cloud data acquired in the scanning unit 20.

The point that differs from the building interior structure recognition system 1 of the embodiment 1 is that the system does not include the second machine learning model generation unit 12 that uses the second site image containing the image of the noise component that does not have the BIM data to carry out the relearning with respect to the first machine-learned model M1, and generates the second machine-learned model. In addition, in the embodiment 2, the third machine learning model generation unit 13 carries out the relearning with respect not to the second machine-learned model M2 but to the first machine-learned model M1, and generates the third machine-learned model M3. That is, in the embodiment 2, the third machine learning model generation unit 13 inputs the set of the correct data and the observation data for the image obtained by removing the extracted noise component from the image inside the building, which is extracted in the noise component removal unit 30, to the first machine-learned model M1 to carry out the relearning, and generates the third machine-learned model M3.

The set of the correct image and the observation image to be used for the relearning with respect to the first machine-learned model M1 is generated from the image obtained by removing the noise component from the third site image in the noise component removal unit 30. The correct image of the image from which the noise component is removed shows the structure in the image so as to be distinguished from the background. The correct image of the image from which the noise component is removed may be manually generated by manually painting out the part of the structure in the image for example. The correct image of the image from which the noise component is removed may be a binary image capable of distinguishing the part of the structure and the background part for example. For the observation image of the image from which the noise component is removed, the image obtained by removing the noise component from the third site image containing the noise component may be used as it is. In addition, for the observation image of the image from which the noise component is removed, the image obtained by processing the image obtained by removing the noise component from the third site image containing the noise component in the preprocessing as needed may be used. The set of such correct image and observation image of the image from which the noise component is removed is used to carry out the relearning processing with respect to the first machine-learned model M1, and the third machine-learned model M3 is generated.

The building interior structure recognition method for recognizing the structure inside the building by using the machine learning model in the embodiment 2 is the building interior structure recognition method for recognizing the structure inside the building by using the machine learning model, including: the step S901 of using the BIM (Building Information Modeling) data and the first site image to carry out the machine learning and generating the first machine-learned model; the scanning step S903 of scanning the interior of the building while determining whether or not the scanning of the structure inside the building is successful, and acquiring the 3D point cloud data of the structure inside the building and the image inside the building; the step S904 of removing the image of the noise component from the image inside the building acquired in the scanning unit; the step S905 of using the image from which the noise component is removed and which is obtained in the removing step to carry out the relearning with respect to the first machine-learned model, and generating the third machine-learned model; the step S906 of using the third machine-learned model to recognize the structure inside the building; and the step S907 of extracting and outputting the point cloud data of the structure inside the building recognized in the building interior structure recognition unit from the 3D point cloud data acquired in the scanning unit.

The point that differs from the building interior structure recognition method of the embodiment 1 is that the method does not include the step S902 of using the second site image containing the image of the noise component that does not have the BIM data to carry out the relearning with respect to the first machine-learned model, and generating the second machine-learned model. In addition, in the embodiment 2, in the step S905 of generating the third machine-learned model, the relearning is carried out with respect not to the second machine-learned model M2 but to the first machine-learned model M1, and the third machine-learned model M3 is generated. That is, in the embodiment 2, the set of the correct data and the observation data for the image obtained by removing the noise component from the third site image containing the noise component in the noise component removal unit 30 is input to the first machine-learned model M1 to carry out the relearning, and the third machine-learned model M3 is generated.

According to the building interior structure recognition system and the building interior structure recognition method according to the present invention described above, shapes and positions can be measured paying attention to members to be paid attention to at a construction site, and accuracy and a speed can be improved. In addition, an amount of the members to be managed at the construction site can be reduced, and as a result, a data amount handled by a member management system at the construction site can be substantially reduced. Further, according to the building interior structure recognition system and the building interior structure recognition method according to the present invention, it is possible to highly accurately recognize even the site image containing the noise components such as wire nets, protective nets and sheets, temporarily installed iron fences and poles, garbage, and building materials that are present at the construction site. In addition, it is possible to improve recognition accuracy of the structure by carrying out the relearning of a model according to the latest site situation corresponding to the noise components that change every moment. Further, since a user can be notified of success or failure of the scanning in the middle of scanning the site and execution of the rescanning can be urged on the spot when the scanning is inferior, it is possible to avoid redoing of scanning work later. In such a manner, according to the present invention, it is possible to cope with various situations specific to the site at the actual site and to minimize time and costs for regenerating a model tailored to the site.

Although the above description has been made regarding the embodiments, it will be apparent to those skilled in the art that the present invention is not limited thereto, and that various changes and modifications can be made within the scope of the principles of the present invention and the appended claims.

### REFERENCE SIGNS LIST

1 Building interior structure recognition system
11 First machine learning model generation unit
12 Second machine learning model generation unit
13 Third machine learning model generation unit
20 Scanning unit
30 Noise component removal unit
40 Building interior structure recognition unit
50 Point cloud data output unit

1. A building interior structure recognition system for recognizing a structure inside a building by using a machine learning model, the building interior structure recognition system comprising:
a first machine learning model generation unit that uses BIM (Building Information Modeling) data and a first site image to carry out machine learning and generates a first machine-learned model;
a second machine learning model generation unit that uses a second site image containing an image of a noise component that does not have the BIM data to carry out relearning with respect to the first machine-learned model, and generates a second machine-learned model;
a scanning unit that scans an interior of the building while determining whether or not scanning of the structure inside the building is successful, and acquires 3D point cloud data inside the building and a third site image;
a noise component removal unit that removes the image of the noise component from the third site image acquired in the scanning unit;
a third machine learning model generation unit that uses an image from which the noise component is removed and which is obtained in the noise component removal unit to carry out the relearning with respect to the second machine-learned model, and generates a third machine-learned model;
a building interior structure recognition unit that uses the third machine-learned model to recognize the structure inside the building; and
a point cloud data output unit that extracts and outputs point cloud data of the structure inside the building recognized in the building interior structure recognition unit from the 3D point cloud data acquired in the scanning unit.

2. A building interior structure recognition system for recognizing a structure inside a building by using a machine learning model, the building interior structure recognition system comprising:
a first machine learning model generation unit that uses BIM (Building Information Modeling) data and a first site image to carry out machine learning and generates a first machine-learned model;
a scanning unit that scans an interior of the building while determining whether or not scanning of the structure inside the building is successful, and acquires 3D point cloud data inside the building and a third site image;
a noise component removal unit that removes an image of a noise component from the third site image acquired in the scanning unit;
a third machine learning model generation unit that uses an image from which the noise component is removed and which is obtained in the noise component removal unit to carry out relearning with respect to the first machine-learned model, and generates a third machine-learned model;
a building interior structure recognition unit that uses the third machine-learned model to recognize the structure inside the building; and
a point cloud data output unit that extracts and outputs point cloud data of the structure inside the building recognized in the building interior structure recognition unit from the 3D point cloud data acquired in the scanning unit.

3. The building interior structure recognition system according to claim 1, wherein the first machine learning model generation unit carries out the machine learning with an image generated from the BIM data as correct data and with an image obtained by processing an image generated by rendering the BIM data using information obtained from the first site image as observation data, and generates the first machine-learned model.

4. The building interior structure recognition system according to claim 1, wherein the second machine learning model generation unit inputs a set of correct data and observation data for the second site image containing the image of the noise component that does not have the BIM data to the first machine-learned model to carry out the relearning, and generates the second machine-learned model.

5. The building interior structure recognition system according to claim 1, wherein the scanning unit acquires an image inside the building, determines whether or not at least one or more corresponding reference points or structures to be references are present between continuous frames, and notifies an alert urging rescanning when the at least one or more corresponding reference points or structures to be references are not present.

6. The building interior structure recognition system according to claim 1, wherein the noise component removal unit extracts the image of the noise component from the third site image acquired in the scanning unit by stereo matching, generates a mask image of the noise component, reconfigures the image so as to interpolate a part of the mask image, and generates the image from which the noise component is removed.

7. The building interior structure recognition system according to claim 1, wherein the third machine learning model generation unit inputs a set of correct data and observation data for an image obtained by removing the noise component from the third site image in the noise component removal unit to the second machine-learned model to carry out the relearning, and generates the third machine-learned model.

8. The building interior structure recognition system according to claim 2, wherein the third machine learning model generation unit inputs a set of correct data and observation data for an image obtained by removing the noise component from the third site image in the noise component removal unit to the first machine-learned model to carry out the relearning, and generates the third machine-learned model.

9. The building interior structure recognition system according to claim 1, wherein the building interior structure recognition unit inputs the third site image to the third machine-learned model, and recognizes the structure inside the building contained in the third site image.

10. A building interior structure recognition method for recognizing a structure inside a building by using a machine learning model, the building interior structure recognition method comprising:
a step of using BIM (Building Information Modeling) data and a first site image to carry out machine learning and generating a first machine-learned model;
a step of using a second site image containing an image of a noise component that does not have the BIM data to carry out relearning with respect to the first machine-learned model, and generating a second machine-learned model;
a scanning step of scanning an interior of the building while determining whether or not scanning of the structure inside the building is successful, and acquiring 3D point cloud data of the structure inside the building and a third site image;
a step of removing the image of the noise component from the image inside the building acquired in the scanning step;
a step of using an image from which the noise component is removed and which is obtained in the removing step to carry out the relearning with respect to the second machine-learned model, and generating a third machine-learned model;
a step of using the third machine-learned model to recognize the structure inside the building; and
a step of extracting and outputting point cloud data of the structure inside the building recognized in the recognizing step from the 3D point cloud data acquired in the scanning step.

11. The building interior structure recognition method according to claim 10, wherein the scanning step acquires an image inside the building, determines whether or not at least one or more corresponding reference points or structures to be references are present between continuous frames, and notifies an alert urging rescanning when the at least one or more corresponding reference points or structures to be references are not present.

12. A building interior structure recognition method for recognizing a structure inside a building by using a machine learning model, the building interior structure recognition method comprising:
a step of using BIM (Building Information Modeling) data and a first site image to carry out machine learning and generating a first machine-learned model;
a scanning step of scanning an interior of the building while determining whether or not scanning of the structure inside the building is successful, and acquiring 3D point cloud data of the structure inside the building and an image inside the building;
a step of removing an image of a noise component from the image inside the building acquired in the scanning step;
a step of using an image from which the noise component is removed and which is obtained in the removing step to carry out relearning with respect to the first machine-learned model, and generating a third machine-learned model;
a step of using the third machine-learned model to recognize the structure inside the building; and
a step of extracting and outputting point cloud data of the structure inside the building recognized in the recognizing step from the 3D point cloud data acquired in the scanning step.

13. The building interior structure recognition method according to claim 12, wherein the scanning step acquires the image inside the building, determines whether or not at least one or more corresponding reference points or structures to be references are present between continuous frames, and notifies an alert urging rescanning when the at least one or more corresponding reference points or structures to be references are not present.

14. A program that causes a computer to execute each step of the method according to claim 10.

15. The building interior structure recognition system according to claim 2, wherein the first machine learning model generation unit carries out the machine learning with an image generated from the BIM data as correct data and with an image obtained by processing an image generated by rendering the BIM data using information obtained from the first site image as observation data, and generates the first machine-learned model.

16. The building interior structure recognition system according to claim 2, wherein the scanning unit acquires an image inside the building, determines whether or not at least one or more corresponding reference points or structures to be references are present between continuous frames, and notifies an alert urging rescanning when the at least one or more corresponding reference points or structures to be references are not present.

17. The building interior structure recognition system according to claim 2, wherein the noise component removal unit extracts the image of the noise component from the third site image acquired in the scanning unit by stereo matching, generates a mask image of the noise component, reconfigures the image so as to interpolate a part of the mask image, and generates the image from which the noise component is removed.

18. The building interior structure recognition system according to claim 2, wherein the building interior structure recognition unit inputs the third site image to the third machine-learned model, and recognizes the structure inside the building contained in the third site image.

19. A program that causes a computer to execute each step of the method according to claim 2.
